(19) United States
(12) Patent Application Publication
(10) Pub. No.: US 2009/0282074 A1
(43) Pub. Date: Nov. 12, 2009

(54) Document Creator

(76) Inventor: Anand Balaji Ramakrishnan, Houston, TX (US)

Correspondence Address: Anand Ramakrishnan, 12831 Woodlite Ln., Houston, TX, 77015, US

(21) Appl. No.: 12/116,464

(22) Filed: May 7, 2008

(51) Int. Cl. G06F 17/30

(52) U.S. Cl. 707/103 Y; 707/E17.011

(57) ABSTRACT

Embodiments of the present invention provide techniques for creating a template document for responding to an Office Action.

### BACKGROUND OF THE INVENTION

1. Field of the Invention

Embodiments of the present invention generally relate to the creation of a document from another document.

2. Description of the Related Art

When responding to an Office Action during the course of prosecuting a patent, a detailed analysis of the Office Action is necessary. References cited in the Office Action must be obtained for detailed analysis. Additionally, a document for responding to the Office Action must be created. Often, the practitioner may need to obtain references or other necessary documents and this is often a time consuming process.

Accordingly, what is needed is a fast way to obtain documents that may be needed to respond to the Office Action and to create a document that is ready for a practitioner to use to respond to the Office Action.

### BRIEF DESCRIPTION OF THE DRAWINGS

So that features of the present invention can be understood in detail, a particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view of a network according to an embodiment of the present invention.

FIG. 2 is a flow chart of example operations for document creation according to an embodiment of the present invention.

FIG. 3 is a view of parts of an Office Action according to an embodiment of the present invention.

FIG. 4 is a view of a created document according to an embodiment of the present invention.

### DETAILED DESCRIPTION OF THE PREFERRED EMBODIMENTS

Embodiments of the present invention provide techniques for creating a template document for responding to an Office Action.

### Example Network Topology

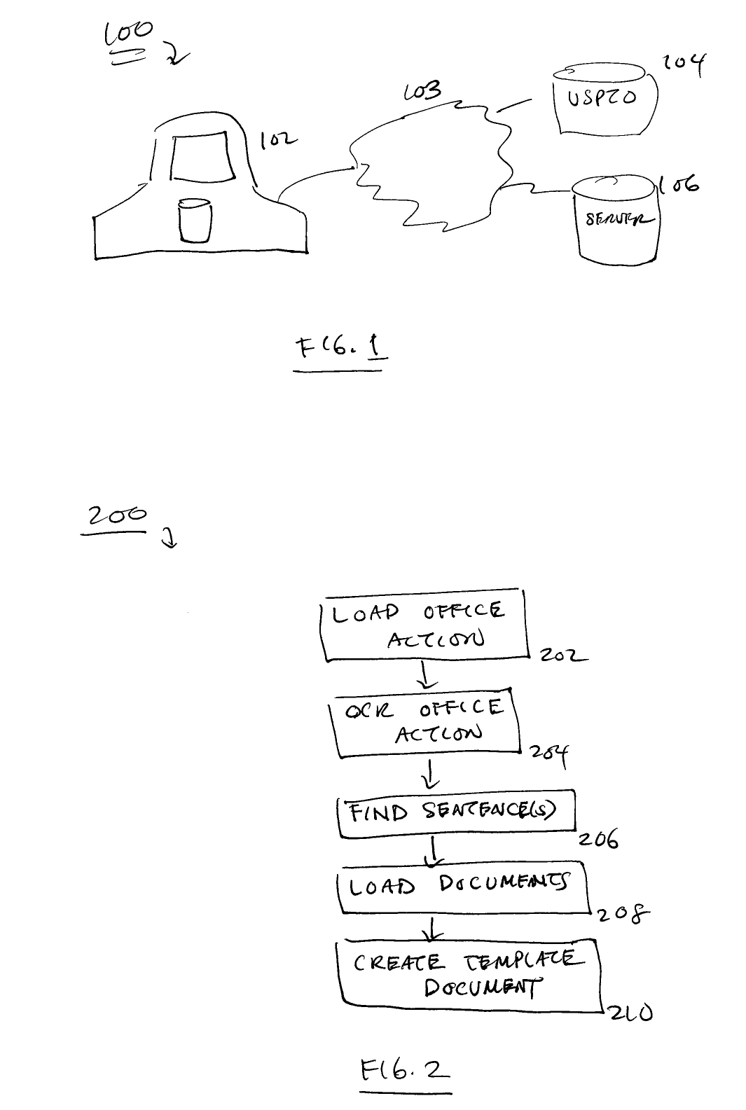

FIG. 1 illustrates an example network 100 in which the embodiments of the present invention may be utilized. A computer 102 may be connected through a network 103 to the United States Patent and Trademark Office server 104, and a web server 106. The network 103 may be the Internet. The computer may be installed with optical character recognition (OCR) software. The web server 106 may store patent documents such as patent publications and patents.

### Document Creation

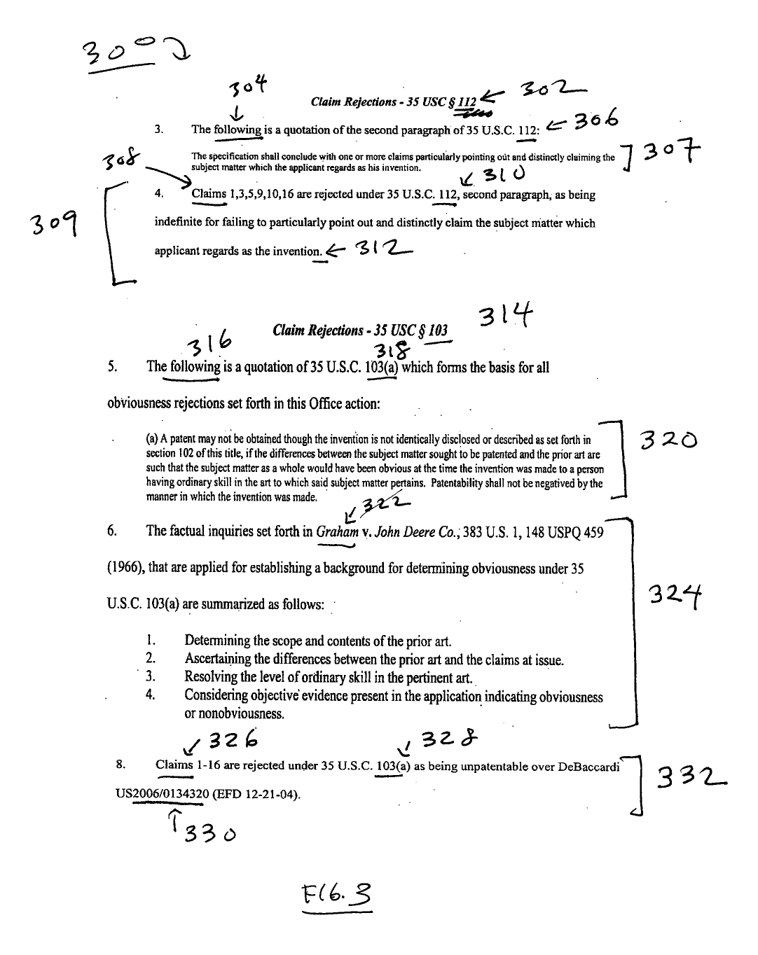

FIG. 2 is a flow chart of example operations 200 for document creation according to an embodiment of the present invention. The operations 200 begin at 202, by loading an Office Action. An Office Action may be loaded from the USPTO server 104 or may already be present on the computer 102 and may be loaded into memory. At 204, OCR may be performed on the loaded Office Action that may create a data stream.

At 206, the one or more keywords may be detected in the data stream. A keyword may be anything in the Office Action that would be useful in response to an Office Action. The data stream may be divided into sentences by using Practical Extraction and Reporting Language's (PERL) SPLIT function (e.g. SPLIT(/./, $datastream), to separate a string into sentences). After splitting the data stream into sentences, each sentence may be searched for a keyword(s).

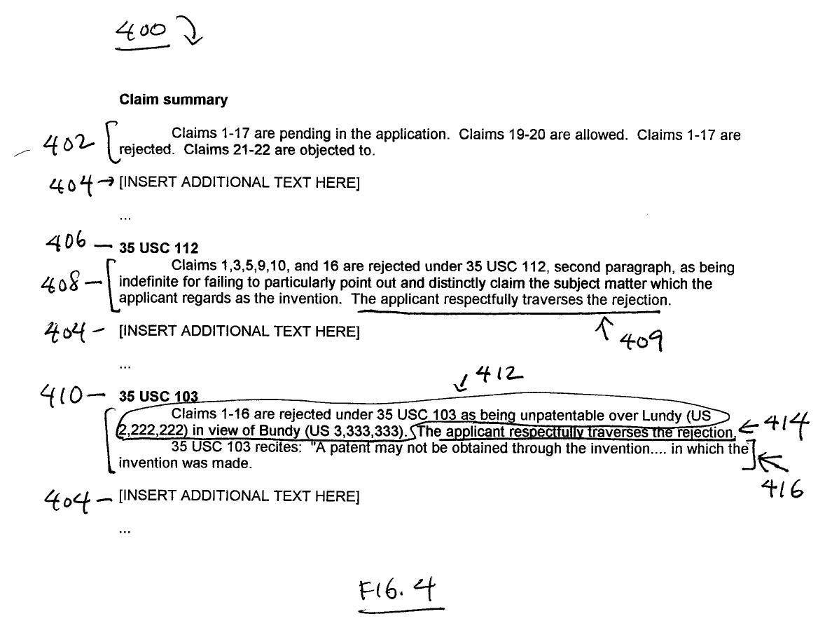

A keyword may be “103” and “claim.” Since, often, the only sentences where the Examiner explicitly states the rejection are likely to have keywords such as “103” and “claim” in them, it is likely that this sentence may be used in a response to the Office Action. For example, the rejection sentence 332 in FIG. 3 has both “103” and “claim” in it. This rejection sentence 332 of the Office Action is a useful sentence to start out the traversal of the rejection in the Office Action response 400 as shown in 412 of FIG. 4. Other combinations of keywords to search for along with “claim,” “112,” and “claim,” “102,” and “claim,” “double patenting,” and “claim,” “101,” or any combination of keywords that designate a rejection or objection and set of claims that correspond to the rejection.

At 208, documents useful in responding to the Office Action are loaded. They may be downloaded from a web server 106 or may be present on the computer 102. The data stream may be searched with a regular expression that matchs “****/*******” for a publication or “*,***,***” for a patent where * represents a digit. In PERL for example, regular expression may be “[d]+/[d]+” for a publication or “[d][d|,]” for a patents. Any suitable language or regular expression that accurately extracts patent publications or patent numbers may be used. After these numbers are extracted (e.g. publication 330 in FIG. 3), they may be downloaded by number from the web server 106 and stored locally at the computer 102 for easy access if they are not already in the computer 102.

At 210, a document template is created. The document template may contain on or more of the sentences described in 206. The creation of the template document may include the addition of one or more sentences or part of a sentence or sentences from the data stream. The document may be a text document or any other document such as a Microsoft Word document.

FIG. 3 is a view of parts of an Office Action 300 according to an embodiment of the present invention and FIG. 4 is a view of a document created according to an embodiment of the present invention. A rejection 302, 314 is stated in the pages of an Office Action 300. When OCR is performed on the Office Action 300 (using ABBYY Finereader or any suitable OCR software), a data stream of the characters in the Office Action may be created. The data stream may be split up into sentences using sentence markers 312 such as a period that divide a document into sentences. The particular rejection often recites the law 307, 320, 324.

In order to create a template document 400 for a practitioner to start from, the sentences of the data stream are searched for keywords 308, 310 or 326 and 328. The information regarding how many claims are pending have been allowed, rejected, objected to, and are the subject of a restriction requirement may be extracted from the data stream and summarized as shown in the claims summary 402. When a sentence is found where a keyword 310, 328, matches a rejection 302, 318 respectfully, the rejection sentence 309, 332 is added to the created document.

For example, when “claim” and “112” are found in the rejection sentence 309, a rejection heading 406 may be created in a template document 400. Then, the rejection sentence 309 may be added as 408 along with a stock statement of traversal 409, 414. Then, an additional text section 404 may be added indicating a section where the practitioner may add substantive comments about the rejection.

Similarly, when the “claim” and “103” are found in the rejection sentence 332, the rejection heading 410 may be created and the rejection sentence 332 may be added as 412 along with a stock statement of traversal 404. Additionally, a statement of the law 320 may be added as 416 in the document.

The document may be edited and used bye the practitioner and the downloaded patent documents may be analyzed.

While the foregoing is directed to embodiments of the present invention, other and further embodiments of the invention may be devised without departing from the basic scope thereof, and the scope thereof is determined by the claims that follow.

1-14. (canceled)

15. A method comprising:
Loading a file into memory on a computer from a network;
Optically scanning the file into a data structure;
Viewing one or more of the data structure according to one or more patterns configured by a user wherein the one or more portions has a beginning and an end according to another pattern and wherein the one or more patterns use a regular expression based searching method using one or more symbols indicating one or more character matches;
Breaking the one or more viewed portion of the data structure into one or more output parts according to a format set by a user; and
Outputting the one or more output parts according to a document form with headings corresponding to one or more of the one or more output parts that correspond to a document to responding to correspondence.

16. The method of claim 15, wherein the one or more viewed portion of the data structure is a rejection.

17. The method of claim 15, wherein the one or more patterns separate one or more viewed portion of the data structure into a rejection sentence.

18. The method of claim 15, wherein the one or more output parts is a rejection sentence.

19. The method of claim 15, wherein the document form corresponds to the form of a reply to correspondence from the patent office.

20. The method of claim 15, wherein the headings correspond to one or more headings from correspondence from the patent office.

21. The method of claim 15, the loading of the file into memory is preceded by downloading a file from the network.

22. The method of claim 15, wherein the one or more portions of a data structure comprise a statement of law.

23. An apparatus comprising:
Loading a file into memory on a computer from a network;
Optically scanning the file into a data structure;
Viewing one or more of the data structure according to one or more patterns configured by a user wherein the one or more portions has a beginning and an end according to another pattern and wherein the one or more patterns use a regular expression based searching method using one or more symbols indicating one or more character matches;
Breaking the one or more viewed portion of the data structure into one or more output parts according to a format set by a user; and
Outputting the one or more output parts according to a document form with headings corresponding to one or more of the one or more output parts that correspond to a document to responding to correspondence.

24. The apparatus of claim 23, wherein the one or more viewed portion of the data structure is a rejection.

25. The apparatus of claim 23, wherein the one or more patterns separate one or more viewed portion of the data structure into a rejection sentence.

26. The apparatus of claim 23, wherein the one or more output parts is a rejection sentence.

27. The apparatus of claim 23, wherein the document form corresponds to the form of a reply to correspondence from the patent office

28. The apparatus of claim 23, wherein the headings correspond to one or more headings from correspondence from the patent office.

29. The apparatus of claim 23, the loading of the file into memory is preceded by downloading a file from the network.

30. The apparatus of claim 23, wherein the one or more portions of a data structure comprise a statement of law.

31. A method comprising:
Loading a file into memory on a computer from a network;
Optically scanning the file into a data structure;
Viewing one or more of the data structure according to one or more patterns configured by a user wherein the one or more portions has a beginning and an end according to another pattern and wherein the one or more patterns use a regular expression using one or more symbols indicating one or more character matches;
Breaking the one or more viewed portion of the data structure into one or more output parts according to a format set by a user; and
Outputting the one or more output parts according to a document form with headings corresponding to one or more of the one or more output parts that correspond to a document to responding to correspondence.

32. A method comprising:
Loading a file into memory on a computer from a network;
Optically scanning the file into a data structure;
Viewing one or more of the data structure according to one or more patterns wherein the one or more portions has a beginning and an end according to another pattern and wherein the one or more patterns and the another pattern use a regular expression using one or more symbols indicating one or more character matches;
Breaking the one or more viewed portion of the data structure into one or more output parts according to a format set by a user; and
Outputting the one or more output parts according to a document form with headings corresponding to one or more of the one or more output parts that correspond to a document to responding to correspondence.

33. A method comprising:
Loading a file into memory on a computer from a network;
Optically scanning the file into a data structure;
Viewing one or more of the data structure according to one or more patterns configured by a user wherein the one or more portions has a beginning and an end according to another pattern and wherein the one or more patterns use a regular expression based searching method using one or more symbols indicating one or more character matches and wherein the another pattern matches a sentence;
Breaking the one or more viewed portion of the data structure into one or more output parts according to a format set by a user; and
Outputting the one or more output parts according to a document form with headings corresponding to one or more of the one or more output parts that correspond to a document to responding to correspondence.

34. A method comprising:
Loading a file into memory on a computer from a network;
Optically scanning the file into a data structure;
Viewing one or more of the data structure according to one or more patterns configured by a user wherein the one or more portions has a beginning and an end according to another pattern and wherein the one or more patterns use a regular expression based searching method using one or more symbols indicating one or more character matches;
Breaking the one or more viewed portion of the data structure into one or more output parts according to a format set by a user; and
Outputting the one or more output parts according to a document form with headings corresponding to one or more of the one or more output parts that correspond to a document to responding to correspondence.
